(19) United States
(12) Patent Application Publication
(10) Pub. No.: US 2010/0027829 A1
(43) Pub. Date: Feb. 4, 2010

(54) CIRCUIT ARRANGEMENT FOR A SOUND REPRODUCER WITH LINEARIZED SOUND TRANSMISSION

(76) Inventor: Laszlo Babos, Erd (HU)

Correspondence Address: BIRCH STEWART KOLASCH & BIRCH, PO BOX 747, FALLS CHURCH, VA, 22040-0747, US

(21) Appl. No.: 12/524,836

(22) PCT Filed: Jan. 28, 2008
(86) PCT No.: PCT/HU08/00009

§ 371 Date: Sep. 22, 2009

(30) Foreign Application Priority Data
Jan. 29, 2007 (HU) P0700097

(51) Int. Cl. H04R 1/20

(52) U.S. Cl. 381/345

(57) ABSTRACT

Circuit arrangement for a sound reproducer with linearized sound transmission comprising a loudspeaker (6) mounted in an enclosure, said arrangement further comprises conducting cables (4,5) connected to the output terminals (2,3) of an amplifier and an impedance member connected serially to said loudspeaker (6). The impedance Rₚᵣₑ of the impedance member is: formula (I) where R_{b} is the impedance of the loudspeaker block, and Q_{tc}, is the quality factor of the built in loudspeaker (6).

$${R}_{pre} = \frac{{R}_{b} * ( 1 - {Q}_{tc} )}{{Q}_{tc}} \qquad ( I )$$

The present invention relates to a circuit arrangement for a sound reproducer with linearized sound transmission comprising a loudspeaker mounted in an enclosure. The arrangement further comprises connecting cables connected to the output terminals of an amplifier and an impedance member connected serially to the loudspeaker.

Sound techniques are known in which the frequency characteristic of loudspeakers, sound reproducers is linearized in order to provide high fidelity sound reproduction. A possible solution can be when the sound range to be radiated is separated into a number of different frequency range, in this manner the individual loudspeakers operate in a narrow range thereby linearity can be ensured easily. Separation of the frequency ranges takes place by means of crossovers. A passive electronic solution for linearizing the low frequency ranges of the loudspeakers has not been found yet. The pulse transmission of the loudspeakers in known loudspeaker systems is unsatisfactory, they only provide for compromised fidelity of sound.

It has been known from the technical literature that selection of loudspeakers especially of the bass ones can not be optimized in respect of their built in parameters. The book titled Hangdoboz-épités (Building suondboxes) (Klinger, Marktech Kft., Budapest, 1991) deals with this subject. According to it a rough division can be made on the basis of the following relation:

$$F = \frac{{f}_{s}}{{Q}_{ts}}$$

in which: fₛ is the resonance frequency of the non built in loudspeaker and Qₜₛ is the quality factor of the non built in loudspeaker.

Usually, the value of F is less than 120 Hz. However, it has been realized that with a certain topology design assembling of an enclosure and loudspeaker system becomes possible by using numerical relations in connection with the topology, and in spite of a small sized enclosure the linearity, thereby the high fidelity sound reproduction is ensured in a wide frequency range. This holds true for sounds in the low-frequency range, in which case it is an especially surprising feature.

Accordingly, the object of the present invention is to provide a circuit arrangement for loudspeakers in which linear operation of the loudspeaker becomes possible through proper selection of the pre-impedance. This object is achieved by the solution according to the preamble in which the value of the pre-impedance connected serially to the loudspeaker is:

$${R}_{pre} = \frac{{R}_{b} * ( 1 - {Q}_{tc} )}{{Q}_{tc}}$$

in which:

R_{b} is the impedance of the loudspeaker block, and

Q_{tc} is the quality factor of the built in loudspeaker.

Generally, the impedance R_{b} of the loudspeaker block equals to the direct-current resistance Rₑ of the loudspeaker. In a certain case it may be influenced by a capacitor connected parallel with the loudspeaker, which—depending on the frequency—decreases the impedance R_{b} of the loudspeaker block to a value smaller than the direct-current resistance Rₑ of the loudspeaker.

In an advantageous embodiment other values of Rₚᵣₑ different from the calculated one by not more than ±50% if F<100 Hz, and by not more than ±30% if F>100 Hz are feasible.

In a more advantageous embodiment other values of Rₚᵣₑ different from the calculated one by not more than ±15% if F<100 Hz, and by not more than ±10% if F>100 Hz are feasible.

Certain parameters of the built in loudspeakers may change after mounting in and in the individual cases this fact may have an influence on the value of the pre-impedance calculated with the formula. Therefore the calculated value should be adjusted to the different conditions resulting from the mounting in. To this a simple control measurement may be performed. In case of other embodiments the given complex pre-impedance may be realized by a cable connecting the loudspeaker and the amplifier.

In the following the circuit arrangement of the loudspeaker mounted in the enclosure and other details of the invention will be disclosed with reference to the accompanying drawings in which:

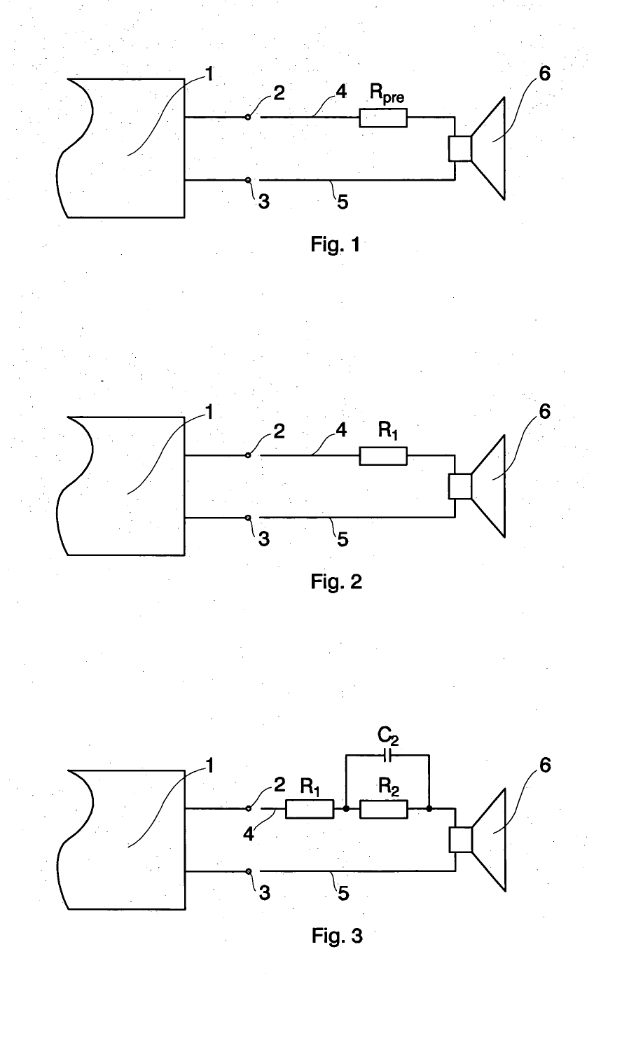

FIG. 1 schematically shows a circuit arrangement of a first possible embodiment of the invention;

FIG. 2 schematically shows a circuit arrangement of another possible embodiment of the invention;

FIG. 3 schematically shows a circuit arrangement of a further possible embodiment of the invention;

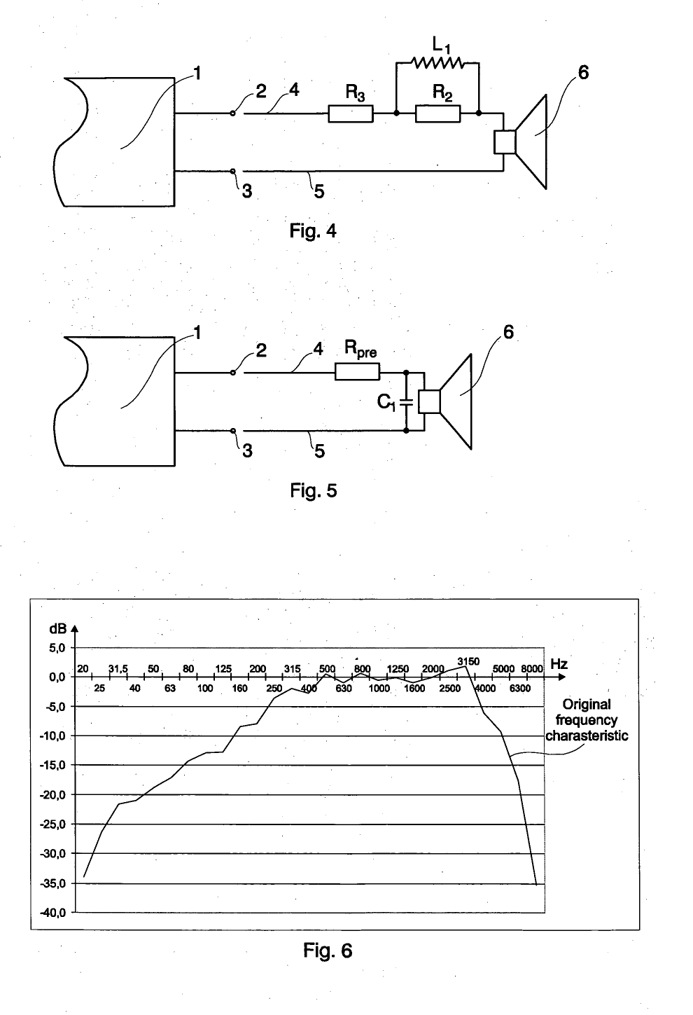

FIG. 4 schematically shows a circuit arrangement of a further embodiment of the invention;

FIG. 5 schematically shows a circuit arrangement of a modified possible embodiment of the invention;

FIG. 6 shows the measured frequency characteristic of an exemplary high quality loudspeaker;

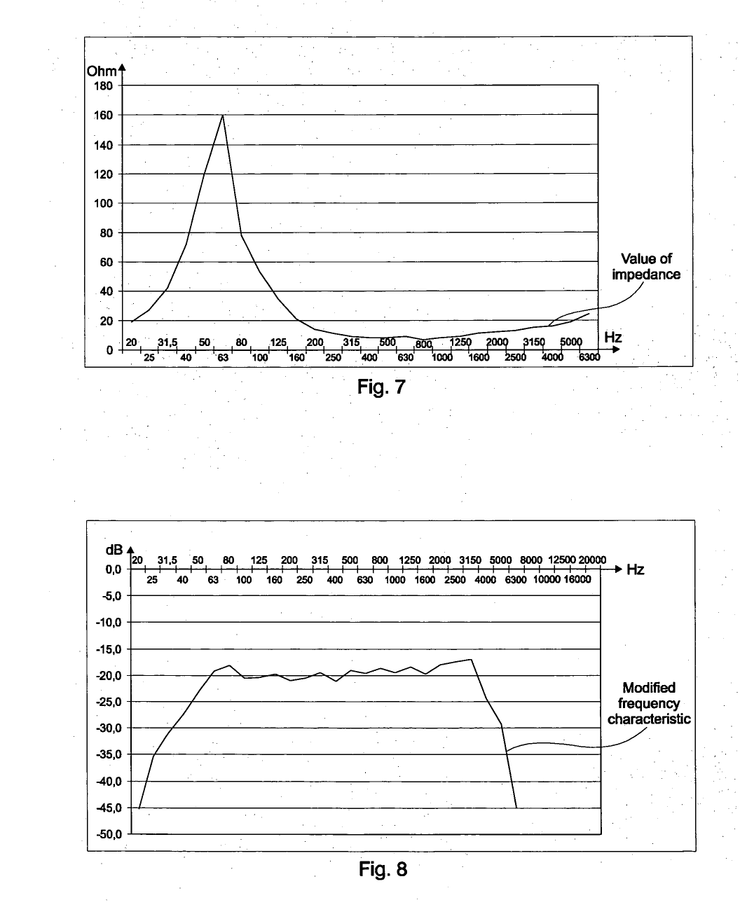

FIG. 7 shows the changes in the impedance values of the loudspeaker of FIG. 6 as a function of frequency; and

FIG. 8 shows the frequency characteristic of the loudspeaker of FIG. 6, when the serial impedance Rₚᵣₑ according to the invention is mounted in.

According to FIG. 1 the circuit arrangement and mounting of the loudspeaker is implemented so that connecting cables 4, 5 which are good conductors i.e. they have low impedance, are coupled to the output terminals 2, 3 of the amplifier 1. Before the loudspeaker 6 an impedance member or pre-impedance Rₚᵣₑ is placed. In the Figure this impedance Rₚᵣₑ is connected serially to the loudspeaker. Impedance Rₚᵣₑ may be an ohmic resistor R₁ as it is shown in FIG. 2. However, it may be a complex effective resistor completed with a parallel capacitive or inductive member as it can be seen later with reference to FIGS. 3 and 4.

It has been found that impedance Rₚᵣₑ may be selected effectively on the basis of the following formula:

$${R}_{pre} = \frac{{R}_{b} * ( 1 - {Q}_{tc} )}{{Q}_{tc}}$$

As it has already been mentioned:

R_{b} is the impedance of the loudspeaker, and

Q_{tc} is the quality factor of the built in loudspeaker.

Generally, the impedance R_{b} of the loudspeaker block equals to the direct-current resistance Rₑ of the loudspeaker. This holds true for embodiments according to FIGS. 1-4.

In case of a given non built in loudspeaker the numerical value of the quality factor Q_{tc} is generally known or it can be calculated from other parameters of the loudspeaker. The way of calculating the quality factor Q_{tc} in case of a built in loudspeaker will be disclosed later.

In order to make use of the impedance Rₑ defined with the above formula possible, it can be divided into several discrete electric components. For example it can be realized by a resistance R₁ and a complex member connected serially to it. This complex member comprises a resistance R₂ and a C₂ condenser connected parallel, as it can be seen in FIG. 3. In a certain case resistance R₂ can be omitted, it can be replaced by a cut-off.

In the solution shown in FIG. 4 inductance L1 is connected parallel with resistance R₂ and a serial resistance R₃ is also employed. The essence of this solution is that in lower frequency ranges the effect of voltage dividing is less, thereby the power loss is decreased. Also, in a certain case resistance R₂ can be omitted, it can be replaced by a cut-off.

Further, it is possible—either in case of embodiments according to FIGS. 2, 3 or 4—to connect a capacitor C₁ parallel to the loudspeaker as it is shown in FIG. 5. In this manner the value of resistance Rₑ of the loudspeaker is modified so that it will be a complex number as it is known from electrical engineering. Consequently impedance Rₚᵣₑ will also be a complex number.

A further possibility can be to select connecting cables 4,5 as distributed parameter network, so that the suitably calculated impedance Rₚᵣₑ is jointly ensured for loudspeaker 6.

In a preferred embodiment of the invention (when a non-distributed parameter network is applied) the discrete members—e.g. resistance R₁ or R₂, capacitor C₂—are located within the enclosure near the loudspeaker 6. Since the given circuit together with the loudspeaker 6 forms a divider, only a part of the driving power is applied to the loudspeaker 6, which results in a negligible power loss. Essentially, this is the price paid for the possibility of the high fidelity linear transmission which is attainable by means of a single loudspeaker, even with one not necessarily designed for reproducing low-frequency sounds.

The value of the real or complex pre-resistance, that is the impedance Rₚᵣₑ must be determined so that the resultant frequency characteristic is the most linear possible. In this manner with a loudspeaker 6 having a resonance frequency of 50 Hz, but with a 12 dB reduction of sound pressure measured at this frequency relative to the general frequency characteristic of the loudspeaker, a linear sound image will be obtained when impedance Rₚᵣₑ is applied. In this manner loudspeakers having a higher quality factor Qₜₛ—even compared to poorer quality loudspeakers 6—ensure surprisingly good linear sound reproduction.

The solution according to the invention can also be used as a crossover in which case for example a plurality of loudspeakers of different types are mounted in a common enclosure. The individual loudspeakers are parallel connected to the amplifier and by placing one of the above circuit arrangements before the loudspeaker whose frequency characteristic is intended to be modified the invention can be applied.

The essence of the effect attainable with the arrangement of the invention is that the serial impedance Rₚᵣₑ together with the loudspeaker 6 forms a voltage divider which as a function of the frequency non-linearly reduces the current amount flowing through. Where the value of the alternating-current resistance of the loudspeaker 6 is high, this dividing effect is less than in a case where the value of the alternating-current resistance is lower.

In the following an example will be shown to illustrate the improvement in the frequency characteristic of a high quality mid-range speaker. FIG. 6 shows the frequency characteristic of a such built in loudspeaker without crossover, where the invention is not utilized. The main parameters of the loudspeaker having the frequency characteristic shown in FIG. 6 were as follows:

The direct-current resistance Rₑ of the loudspeaker: 5.5 Ohm

The quality factor Qₜₛ of the non-built in loudspeaker: 0.09

The resonance frequency Fₛ of the loudspeaker: 53 Hz.

FIG. 7 shows the alternating-current resistance of the built in loudspeaker as a function of the frequency. The peak in the impedance which sets limits to the linear sound transmission behavior can be well seen.

FIG. 8 shows the frequency characteristic when serial impedance Rₚᵣₑ selected according to the invention is applied, using an ohmic impedance Rₚᵣₑ.

The quality factor Qₜₛ of the built in loudspeaker can be calculated with the formula as follows (on the basis of Thiele and R. H. Small):

Q_{tc}/Qₜₛ=F_{c}/Fₛ

Where Q_{tc} is the quality factor of the built in loudspeaker.

The resonance frequency F_{c} of the built in loudspeaker is 60 Hz.

Q_{tc}=(F_{c}/Fₛ)*Qₜₛ=(60/53)*0.09=0.10

According to the invention the value of the serial impedance Rₚᵣₑ needed for obtaining linear frequency characteristic of the given loudspeaker has been determined as follows:

$${R}_{pre} = \frac{{R}_{e} \times ( 1 - {Q}_{tc} )}{{Q}_{tc}} = \frac{5.5 * ( 1 - 0.1 )}{0.1} = \frac{4.95}{0.1} = 49.5 Ohm$$

FIG. 8 shows how the frequency characteristic has changed when a resistance Rₚᵣₑ=49.5 is connected parallel with the above mentioned loudspeaker. Significant improvement can be seen especially in the range of low frequency sounds. Also, it can be seen in the Figure that the whole diagram is shifted downwards i.e. the price for this improvement is that the power efficiency is slightly decreased.

The frequency value F=fs/Qts as mentioned in the preamble substantially determines the possible way of mounting the loudspeaker in. If the value F is high, the loudspeaker can be mounted only in a funnel-shaped or exponentially formed enclosure in order to obtain satisfactory linearity. In this case using the solution according to the invention is more reasonable and results in a significant improvement in the frequency characteristic. For example if F>100 Hz the solution according to the invention can be used even if the value of impedance Rₚᵣₑ is different from the correctly calculated value by not more than ±50%. A greater difference would satisfy the requirements of linearization only to a lesser extent. If F<100 Hz then the calculated value of impedance Rₚᵣₑ according to the invention would be smaller, it would be closer to the ohmic value of the wires, therefore a lower degree of tolerance is reasonable, for example a tolerance of only ±30% is preferable.

Advantageously, in order to achieve the object of the invention the degree of tolerance is between ±25% and ±15%.

1. Circuit arrangement for a sound reproducer with linearized sound transmission comprising a loudspeaker (6) mounted in an enclosure, said arrangement further comprises connecting cables (4,5) connected to the output terminals (2,3) of an amplifier and an impedance member connected serially to said loudspeaker (6) characterized in that the impedance Rₚᵣₑ of the impedance member:
$${R}_{pre} = \frac{{R}_{b} * ( 1 - {Q}_{tc} )}{{Q}_{tc}}$$
where R_{b} is the impedance of the loudspeaker block, and Q_{tc} is the quality factor of the built in loudspeaker (6).

2. Circuit arrangement for a sound reproducer according to claim 1 characterized in that the impedance R_{b} of said loudspeaker block equals to the direct-current resistance Rₑ of said loudspeaker (6).

3. Circuit arrangement for a sound reproducer according to claim 1 characterized in that impedance Rₚᵣₑ is ohmic resistance (R₁).

4. Circuit arrangement for a sound reproducer according to claim 1 characterized in that impedance Rₚᵣₑ is a complex member comprising an ohmic resistance (R₁) connected serially to said loudspeaker (6), a further resistance (R₂) connected serially to said resistance (R₁) and a condenser (C₂) connected parallel to said further resistance (R₂).

5. Circuit arrangement for a sound reproducer according to claim 1 characterized in that impedance Rₚᵣₑ is a complex member comprising an ohmic resistance (R₁) connected serially to said loudspeaker (6), a further resistance (R₂) connected serially to said resistance (R₁) and an inductance (L₁) connected parallel to said further resistance (R₂).

6. Circuit arrangement for a sound reproducer according to claim 4 or 5 characterized in that the value of said further resistance (R₂) is infinite or it is replaced by a cut-off.

7. Circuit arrangement for a sound reproducer according to claim 1 characterized in that at least one capacitor (C₁) is connected parallel to said loudspeaker (6).

8. Circuit arrangement for a sound reproducer according to claim 1 or 5 characterized in that said ohmic resistance (R₁) and/or said further resistance (R₂) are realized by connecting cables (4,5) having resistance.

9. Circuit arrangement for a sound reproducer according to claim 8 characterized in that a plurality of loudspeakers of the same type connected parallel are mounted in a common enclosure comprising connecting cables (4,5) coupled to the output terminals (2,3) of an amplifier and an impedance member (Rₚᵣₑ) connected serially to said parallel connected loudspeakers (6), the impedance of said impedance member (Rₚᵣₑ) is defined by the following relation:
$${R}_{pre} = \frac{\frac{{R}_{b} \times ( 1 - {Q}_{tc} )}{{Q}_{tc}}}{number of loudspeakers}$$

10. Circuit arrangement for a sound reproducer according to claim 9 characterized in that the impedance R_{b} of said loudspeaker block equals to the direct-current resistance Rₑ of one loudspeaker (6).

11. Circuit arrangement for a sound reproducer according to claim 8 characterized in that a plurality of loudspeakers of the same type connected parallel are mounted in a common enclosure comprising connecting cables (4,5) coupled to the output terminals (2,3) of an amplifier and an impedance member (Rₚᵣₑ) connected serially to said parallel connected loudspeakers (6), the impedance of said impedance member (Rₚᵣₑ) is defined by the following relation:
$${R}_{pre} = \frac{{R}_{b} \times number of loudspeakers \times ( 1 - {Q}_{tc} )}{{Q}_{tc}}$$
where R_{b} is the impedance of the loudspeaker block, and Q_{tc} is the quality factor of one built in loudspeaker (6).

12. Circuit arrangement for a sound reproducer according to claim 11 characterized in that the impedance R_{b} of said loudspeaker block equals to the direct-current resistance Rₑ of one loudspeaker (6).

13. Circuit arrangement for a sound reproducer according to claim 1 characterized in that if in case of a given loudspeaker (6) the frequency value F=fₛ/Qₜₛ is greater than 100 Hz then the value of the serially connected impedance member may vary from the calculated value of impedance Rₚᵣₑ by a tolerance range of ±50%.

14. Circuit arrangement for a sound reproducer according to claim 13 characterized in that if in case of a given loudspeaker (6) the frequency value F=fₛ/Qₜₛ is greater than 100 Hz then the value of the serially connected impedance member may vary from the calculated value of impedance Rₚᵣₑ by a tolerance range of ±25%.

15. Circuit arrangement for a sound reproducer according to claim 12 characterized in that if in case of a given loudspeaker (6) the frequency value F=fₛ/Qₜₛ is smaller than 100 Hz then the value of the serially connected impedance member may vary from the calculated value of impedance Rₚᵣₑ by a tolerance range of ±30%.

16. Circuit arrangement for a sound reproducer according to claim 15 characterized in that if in case of a given loudspeaker (6) the frequency value F=fₛ/Qₜₛ is smaller than 100 Hz then the value of the serially connected impedance member may vary from the calculated value of impedance Rₚᵣₑ by a tolerance range of ±15%.
